(19) United States
(12) Patent Application Publication
(10) Pub. No.: US 2009/0125935 A1
(43) Pub. Date: May 14, 2009

(54) Method and System for Providing Filtered Video Content Over a Network

(75) Inventors: Yuko Nishikawa, La Jolla, CA (US); Seth Hill, La Mesa, CA (US); Nick Colsey, Del Mar, CA (US); Rajesh Rao, San Marcos, CA (US); Rolf Toft, Palo Alto, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS INC., Park Ridge, NJ (US)

(21) Appl. No.: 11/938,660

(22) Filed: Nov. 12, 2007

(51) Int. Cl. H04N 7/173

(52) U.S. Cl. 725/28

(57) ABSTRACT

The present invention pertains to a method and apparatus for obtaining filtered audiovisual content over a network for display on a television. In one embodiment, the method may include receiving a request for video content, the request including at least one factor that specifies an attribute of the requested video content, and communicating the request and the at least one factor to a content server. The method may also include receiving a response indicating video content available from the content server that satisfies the at least one factor. Furthermore, in one embodiment, the factor is data indicating a TV Parental Rating.

### FIELD OF THE INVENTION

The present invention relates to the field of presenting audiovisual content on a television; more particularly, the present invention relates to obtaining filtered audiovisual content over a network for display on a television.

### BACKGROUND OF THE INVENTION

The internet, as a means for disturbing video and music content, has become ubiquitous. Personal computers are utilized to obtain content from video sharing websites which allow users upload, view, and share video clips, etc. Furthermore, websites allow users to rent or download content in pay-per-view or purchases-based transactions. There are problems, however, with the aforementioned approaches in penetrating the home entertainment market, being user-friendly, and supplying user-appropriate content.

File sharing websites are limited to computers. Thus, the content uploaded and shared on such websites may only be viewed on a personal computer, making extension of such content to a home entertainment system difficult. Furthermore, content sharing websites often supply content that may be inappropriate for certain viewers, as the internet remains virtually unregulated with regard to content ratings, intellectual property protections, etc.

Further, pay-per-view and purchased based content distribution systems are not user-friendly when applied in standard home entertainment scenarios. Purchase based systems are personal computer (PC) centric and require the use of a personal computer or laptops as either the primary content obtainer/distributor or an integral component of the content distribution systems. However, inclusion of a personal computer in a multimedia center is often unwieldy and awkward. Furthermore, dedicating a personal computer to such uses may be overly costly or cannot easily be integrated into an existing home entertainment system.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a network architecture in which embodiments of the present invention may operate.

FIG. 2 illustrates one embodiment of content distribution for providing filtered content.

FIG. 3 illustrates one embodiment of exemplary architectures of a set back box and television in which embodiments of the present invention may operate.

FIG. 4 illustrates one embodiment of a process for a television handling commands to obtained filtered content.

FIG. 5 illustrates one embodiment of a process for a set back box requesting available filtered content.

FIG. 6A illustrates one embodiment of a process for a server receiving a content availability request.

FIG. 6B illustrates one embodiment of a process for a server supplying requested content.

FIG. 6C illustrates one embodiment of a process for a server supplying information pertinent to a content request error.

FIGS. 7A-C show exemplary representations of user interfaces facilitating request and selection of content according to some embodiments of the present invention.

### DETAILED DESCRIPTION OF THE PRESENT INVENTION

A method, apparatus, and system for obtaining filtered audiovisual content over a network for display on a television is described. In one embodiment, the method includes a set back box (SBB) receiving a request for video content including at least one factor which specifies an attribute of the requested video content. The factor may be a specification of a television parental rating of which the requested video content should not exceed. In such a case the request would limit expected results based on a Parent Ratings Scale which is already used in conventional television. The request and the factors are then communicated to one or more content servers.

Subsequent to the request, a response is received from the content servers indicating what video content is available which satisfies the filtering factor of the request. In one embodiment, data included in the response is data indicative of video content, such as title of the video content item, description of the video content item, duration of the video content item, user ratings of the video content item, and a graphical representation of the video content item, etc. However, if the content server does not contain any video content an error icon indicating that video content, which satisfies the at least one factor, is not available from the server. In either case, the responses are communicated for display on the television.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

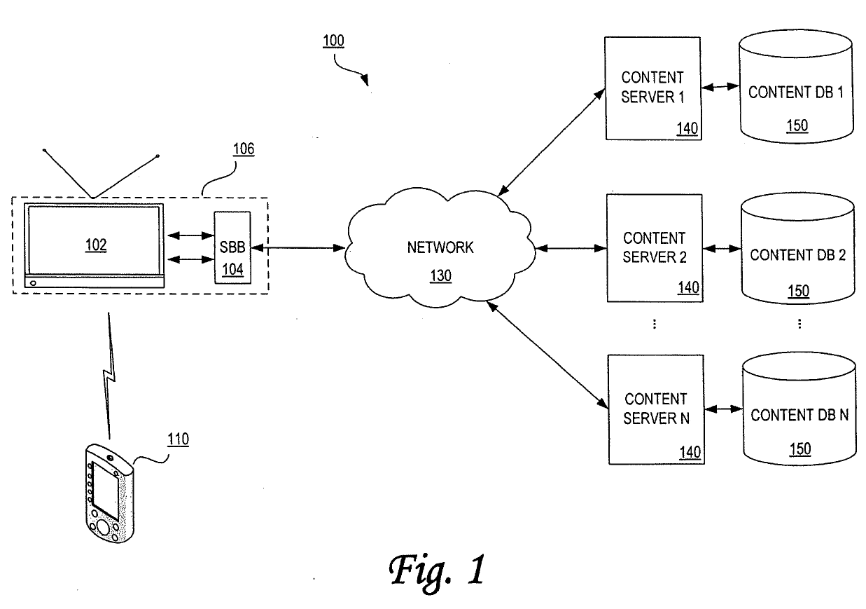

FIG. 1 illustrates one embodiment of a network architecture in which embodiments of the present invention may operate. The architecture 100 includes a set back box (SBB) 104 coupled with a television 102. In one embodiment SBB 104 is communicatively coupled with television 102 by wired or wireless connection. In other embodiments (illustrated by dashed box 106), SBB 104 is embedded within television 102, or physically mounted on the back of television 102.

SBB 104 is coupled to a communications network 130, such as a public network (e.g., the Internet, a wireless network, etc.) or a private network (e.g. a Local Area Network (LAN), Intranet, etc.). The SBB 104 communicates with multiple content servers (content server 1 though content server N) 140 via network 130. The content servers 140 in turn communicate with associated content databases (content DB 1 through content DB N) 150.

As will be discussed in greater detail below, SBB 104 hosts software, hardware, or firmware modules for request, obtaining, and displaying content, subject to various attributes, through television 102. In one embodiment, remote control 110 communicates with television 102 to request video content. Remote control may request video content via a user interface, such as SONY CORP.'s XROSS MEDIA BAR (XMB). The request is communicated by television 102 or passed through television 102 to SBB 104.

In one embodiment, the request is accompanied with at least one factor that specifies an attribute for the requested video and/or audio content, to be supplied by one or more of content servers 1 . . . N 104. Thus, a request received by a user may include one or more factors by which video content, which is ultimately supplied to SBB 104, may be filtered by content servers 140. Such a request may also be selected from a user interface displayed on television 102, and communicated/passed through to SBB 104.

In one embodiment, the factor is a parental rating level. The parental rating level may be any of the TV Parental Guidelines implemented by the Federal Communications Commission, the Canadian TV Classification System, the Commercial Television Industry Code of Practice governed by the Australian Communications and Media Authority, etc. Furthermore, other ratings systems, such as those specified by a user, content ratings systems that have yet to be developed, etc. may be implemented consistently with the description herein.

Furthermore, in one embodiment, the factor utilized in filtering requested video content may include non-ratings factors such as genre, title, content provider, etc. Additionally, any number of factors may be combined in a request. However, to avoid obscuring the present invention and not by way of limitation, future examples will focus on parental ratings as the filtering factor.

SBB 104 composes a request for content, include at least one factor for filtering content, and communicates the request to one or more of content servers 140 via network 130. In one embodiment, the protocol used to communicate the request and the structure of the request are proprietary, however, other standard protocols such as hypertext transport protocol (HTTP), Transmission Control Protocol/Internet Protocol (TCP/IP), etc., together with open data interchange formats such as External Data Representation (XDR) may be used.

One or more of content servers 140 receives the request and queries content databases 150 for content which satisfies the request. When content is available which satisfies the request parameters (e.g., parental rating), content server responds with an indication of the available content to SBB 104. SBB then displays the response on television 102 to a user. In one embodiment, the response includes information for each content item available at a content server 140, such information including which content server will supply the media, a title of the content to be provided, a description, screenshots, reviews, parental ratings etc. The information may be included in the display on television 102.

In one embodiment, a request for a specific content item, displayed as a result of the content availability request, is received by television 102 and forwarded to SBB 104. SBB 104 then requests the specific content item from the appropriate server 140. In response the server 140 provides the content to SBB 104, so that SBB can display the content on television 102. In one embodiment, content server 140 streams content to SBB 104, such that television 102 displays the content provided in the stream, such as an MPEG-4 audiovisual stream or H.264 codec stream. In such a case, SBB 104 receives the encoded data stream, decodes the audiovisual data, and communicates the video and/or sound for display on television 102. In one embodiment, the data stream may optionally be compressed, so that SBB 104 would receive and decompress the encoded data stream prior to display on television 102.

In one embodiment, SBB 104 communicates the audiovisual data to television 102 via a high definition multimedia interface (HDMI) link. However, other links such as component audio and video cables, universal serial bus (USB), IEEE 802.11, etc. links may be utilized between SBB 104 and television 102.

In one embodiment, as discussed below, some content request may fail, such as when no content available on a content server satisfies a parental rating. For example, a request for content may specify information on all content available at a particular server which does not exceed a TV-PG (i.e., a rating that signifies that the program is unsuitable for young children without the guidance of a parent). Depending on the content server and the content currently available at the server, only content that equals or exceeds TV-14 rated content may exist on the server. The content server would accordingly respond with an error message to indicate that no content satisfying the request criteria is available at the server.

In one embodiment, the error message may take the form of a user-selectable error icon, which is displayed by SBB 104 on television 102. The user-selectable icon links to a specific error message stored on a content server 140, such that when it is selected by a user, SBB 104 request the error message indicated by the link. Thus, in certain embodiments, error messages may be graphically displayed and selectable, allowing a user to drill down to the root of a received error message.

Beneficially, SBB 104 does not require support for an external personal computer (PC). Furthermore, because SBB 104 may easily be coupled with, physically mounted on, or embedded within television 102, SBB may easily and seamlessly be integrated into existing home entertainment centers. Furthermore, the utilization of filtering attributes, such as existing parental ratings systems, ensures that appropriate content is supplied when requested by a user of system 100.

Furthermore, in embodiments discussed above, high-definition, extended definition, standard definition, etc. content may be requested and displayed according to system 100.

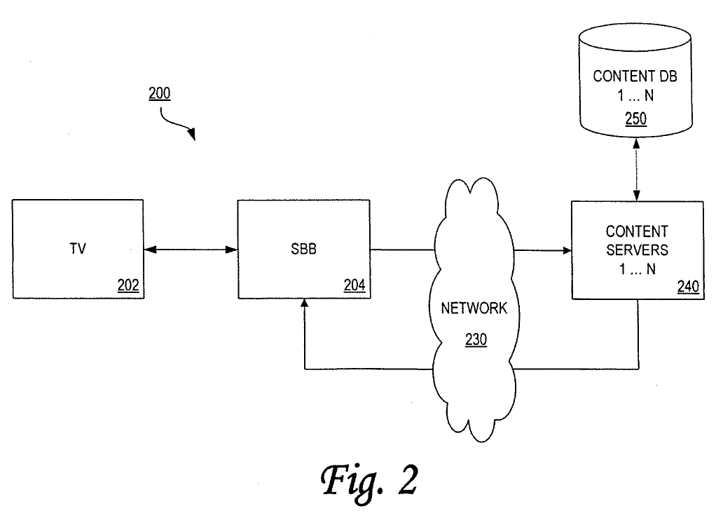

FIG. 2 illustrates one embodiment of content distribution 200 for providing filtered content. According to the embodiment illustrated in FIG. 2, television 202 receives user commands for content including at least on factor for filtering the requested content. As discussed above, the factor may be one or more of a TV parental rating, a genre, etc. Television 202 communicates the request to set back box (SBB) 204.

In one embodiment, upon SBB 204 receiving the request, SBB 204 composes a request to one or more content servers 240 via network 230. The request, which may be an HTTP request, TCP/IP request, etc. is communicated via network 230 to content servers 240. Content servers query associated databases 250 for content that satisfies the factor, such as content which does not exceed a particular TV parental rating. Content servers 240 compose the appropriate response, based on the query results and the filtering factor, and communicate the results to SBB 204 via network 230. As discussed above, the response may be either a response with data indicative of content available at content server 240 which satisfies the request criteria, or the response may be an error message. In either case, SBB 204 causes the response to be displayed on television 202.

SBB 204 may then either receive a request for a specific content item of the prior content availability request, receive a selection of an error icon indicating that no content which satisfies a request is available at the content server 240, or receive a new content availability request. Thus, content filtering criteria, such as TV parental ratings, impact each action for requesting, obtaining, and displaying video content as described herein.

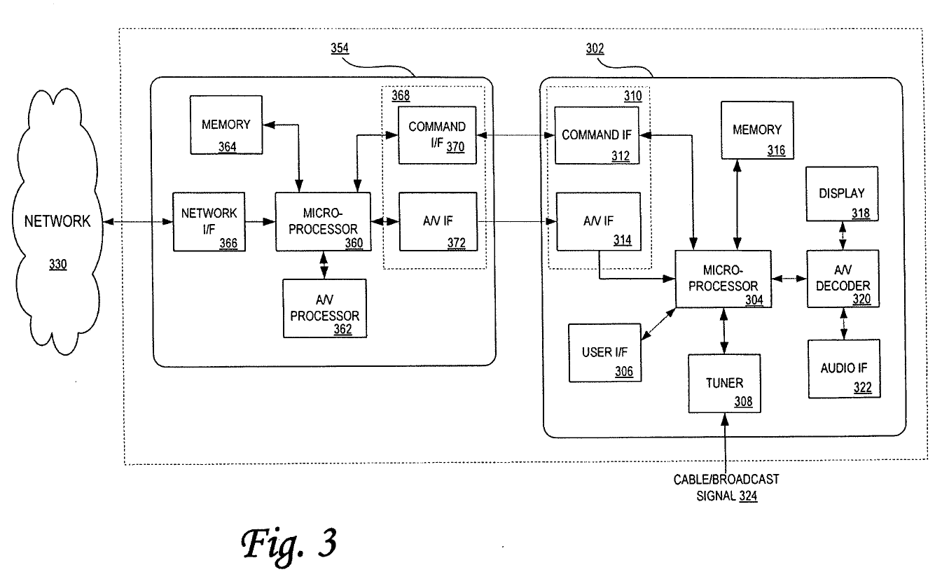

FIG. 3 illustrates one embodiment of exemplary architectures of a set back box and television in which embodiments of the present invention may operate. In one embodiment, television 302 is a standard television, or a high-definition television such as a SONY BRAVIA television. Television 302 includes a user interface 306 for receiving commands from a remote control (not shown), touch screen commands, or special purpose buttons integrated into television 302. Processor 304 receives the commands and takes appropriate action, according to one or more machine readable instructions stored in memory 316, as discussed in greater detail below. For example, user interface 306 may receive request for content availability, filtering criteria such as TV parental ratings, request to obtain specific content, etc.

Television further includes a television tuner 308 for receiving cable, broadcast, satellite, etc. signals. In one embodiment tuner 308 is/includes a high definition tuner for receiving and causing the display of standard, extended, or high definition content, as well as video content of other picture qualities. The television signals are forwarded to audiovisual (A/V) decoder 320 which processes the signal into both audio components and corresponding video components. AV decoder 320 then forwards the video components of a signal to display 318, forwards audio components of a signal to audio interface 322, and synchronizes their playback. In one embodiment, A/V decoder decodes and processes various video quality levels (e.g., high definition, standard definition, etc.) and processes various audio standards such as DOLBY, Digital Theater System 5.1, THX, etc.

In one embodiment, television includes a set back box (SBB) interface 310 communicating with SBB 354. Such an interface may consist of a single interface, such as a FIREWIRE interface, USB interface, etc. for communicating with SBB 354. In one embodiment, interface 310 includes a audiovisual (A/V) interface 314, such as a HDMI or video and/or audio component interfaces. Interface 314 receives video content from SBB 354 and forwards the content through processor 304 and A/V decoder 320 for playback by display 318 and audio interface 322. Furthermore, A/V interface 314 may forward raw audiovisual data to A/V decoder 320 for processing and playback on display 318 and audio interface 322.

In one embodiment interface 310 further includes a non-audiovisual interface, such as a USB interface, for communicating user requests, received at user interface 306 to SBB 354.

SBB 354 includes complementary interface components to those on television 302. In one embodiment, SBB 354 includes interface 368 for receiving commands from television, forwarding content request results to television, forwarding and streaming content to television, etc. In one embodiment, the complementary interfaces include a command interface 370 and an audiovisual interface 372, such as a USB interface and an HDMI interface.

As discussed above, SBB 354 and television 302 may be communicatively coupled via a wired connection between interfaces 310 and 368, or wireless connection between interfaces 310 and 368. Furthermore, SBB 354 may be physically mounted, or docked, on television, as well as being wholly or partially embedded within television.

In one embodiment, SBB 354 receives commands from television via interface 368, and more specifically in some embodiments command interface 370. The commands are forwarded to micro-processor 360 which accesses machine readable instructions stored in memory 364 for processing the received commands, as discussed below. As discussed herein, SBB 354 receives commands to request content from one or more content servers (not shown). The commands are received and requests are composed by processor 360, which are then sent from network interface 366 over network 380 to one or more content servers. Network interface 366 may be a standardized IEEE 802.3 ethernet interface, asynchronous transfer mode interface, etc. Although not shown, network interface 366 may be configured to communicate with network 380 through a LAN, IEEE 802.11 network, a cable modem, digital subscriber line (DSL) modem, etc.

Search results, content, content streams, error messages, etc. are received from one or more content servers (not shown) at network interface 366 and are appropriately processed by micro-processor 360. In one embodiment, microprocessor may utilize A/V processor 362 to decompress, format, convert, etc. the received content data prior to delivery to television 302 via A/V interface 372. However, in other embodiments, a raw and/or compressed data stream is provided to television 302 from SBB 354 where television performs an necessary decompression, formatting, conversion, etc. of content. That is, content data, request response, and/or error messages may be received as MPEG-4 formatted and compressed data, as well as other data formats. Furthermore, the data may be received as a complete representation of specific content, or as a content stream. In each case, the data would be processed by one or more of microprocessor 360, A/V processor 362, microprocessor 304, or A/V decoder 320.

In one embodiment, non-content data are communicated to television 302 from SBB 354 via command interface 370. Such non-content data may include any of graphical user interfaces of SBB 354, filtering options, etc.

Furthermore, memory 364 of SBB 354 may store past request factors (e.g., memory 364 may store the last set of factors utilized in a request, such as recalling the last request for content requested content that did not exceed TV-MA), settings of the SBB, etc.

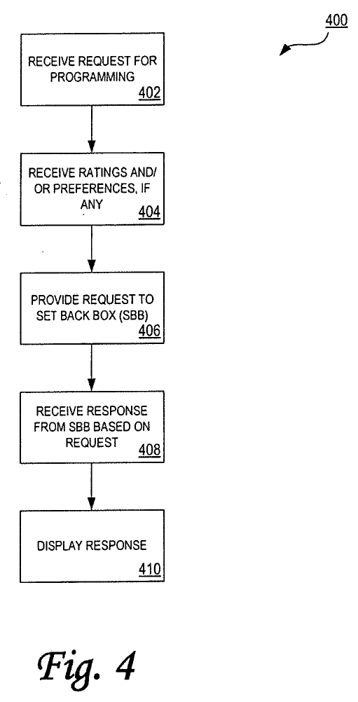

FIG. 4 illustrates one embodiment of a process 400 for a television handling commands to obtained filtered content. The process is performed by processing logic that may comprise hardware (circuitry, dedicated logic, etc.), software (such as is run on a general purpose computer system or a dedicated machine), or a combination of both.

The process begins with processing logic at a television, such as television 302 or television 102, receiving a request for content (processing block 402). As discussed above, the request for content may be a request for programming content or information associated with an error icon displayed on a television. In order to filter contents of the request, processing logic also receives TV Program Ratings, search preferences, specifications of content providers, etc., if any (processing block 404). Because criteria/factors are retained in a memory, as discussed above, or because some request are directed at error icons, not all requests are accompanied by factors that specify attributes of requested audiovisual content.

In one embodiment, the processing logic provides (e.g., communicates or passes through) the request to a set top, such as set back box 104 or set back box 354 (processing block 406). A response from the set back box is received by processing logic (processing block 408) which is then displayed by processing logic on the television (processing block 410). Processing logic then returns to processing block 402 to await the receipt of another request for content, an error icon, data received in response to selection of an error icon, etc.

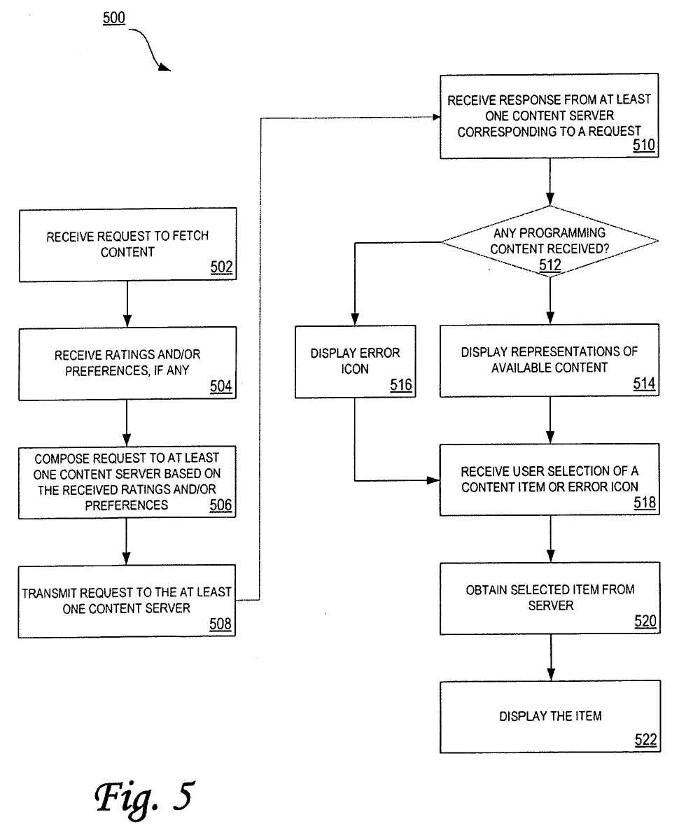

FIG. 5 illustrates one embodiment of a process 500 for a set back box requesting available filtered content. The process is performed by processing logic that may comprise hardware (circuitry, dedicated logic, etc.), software (such as is run on a general purpose computer system or a dedicated machine), or a combination of both.

The process begins with processing logic at a set back box, such as set back box 104 or set back box 354, receiving a request to fetch content (processing block 502). Along with the request to fetch content, content ratings and/or preferences, if any, are also received by processing logic (processing block 504). As discussed above, content may be request from one or more content servers over a network. Furthermore, processing logic of FIG. 5 does not rely on a personal computer to request, obtain, and display content on a television.

In one embodiment, the ratings are standard TV Parental Guidelines ratings, Canadian TV Classification System ratings, Commercial Television Industry Code of Practice ratings, etc., as well as yet to be developed ratings systems. In addition to program ratings, a request may also include other factors, which bear on the attributes of requested video, such as content provider, genre, topic, actor, etc.

Processing logic composes the request for transmission to at least one content server based on the received ratings and/or preferences (processing block 506). In one embodiment, the request is composed as an HTTP request, a TCP/IP request, etc., or multiple requests corresponding to different communications standards. The request is then transmitted to the at least one content server (processing block 508).

In one embodiment, processing logic then receives a response from at least one content server which corresponds to the request of processing blocks 506-508 (processing block 510). As noted above, the response may be either data indicating which content is available which satisfies request criteria, or an error message. Thus, processing logic determines if data indicating audiovisual content, to be played on a television, was received (processing block 512).

If no content was received by processing logic, an error icon is displayed (processing block 516). In one embodiment, the received error message is received as a user-selectable error icon which links to a specific error message. For example, content may be requested from content servers which does not exceed a TV-Y rating (e.g., programming that is suitable for all ages with themes and content in programs that are specifically aimed at a young audiences). However, a specific content server may not include any content which has been supplied with such a rating. In this case, an error icon would be received by processing logic and displayed at processing block 516. Because the error icon links to a specific error message, and as discussed below, when selected by a user the linked data may cause processing logic to retrieve an error message indicating that content which does not exceed a TV-Y rating is available at a content server.

However, if content data is determined to have been received processing logic causes the display of the content data (processing block 514). In one embodiment, the data providing the representation of available content includes a preview clip, a still image, a graphic, etc. which provides visual data regarding each particular program. Furthermore, other data, such as reviews, TV rating, description, actors, etc. may also be received and displayed.

In either case, processing logic may then receive a user selection of either the displayed error icon or a specific content item (processing block 518). The selected item is then obtained from the corresponding content server (processing block 520) and caused to be displayed on a television (processing block 522). In one embodiment, a request for the content associated via a link to an error message is requested and then displayed. In another embodiment, a specific content item, such as a television show, is requested and displayed by processing logic. In one embodiment, processing logic receives a content stream and cause the stream to be displayed on a television. In another embodiment, and entire file, corresponding to the requested content item, is received and then displayed.

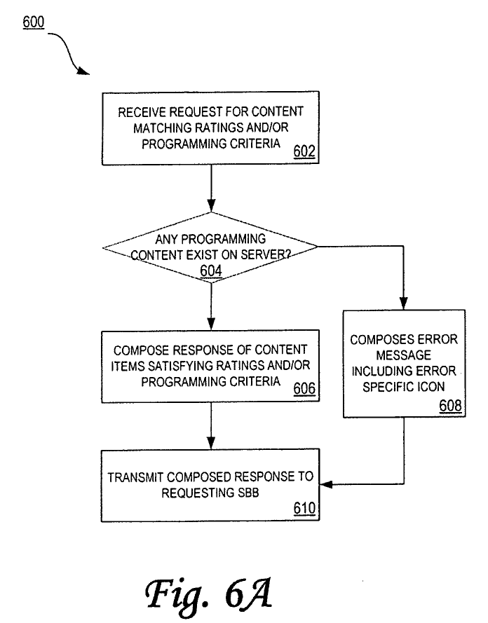

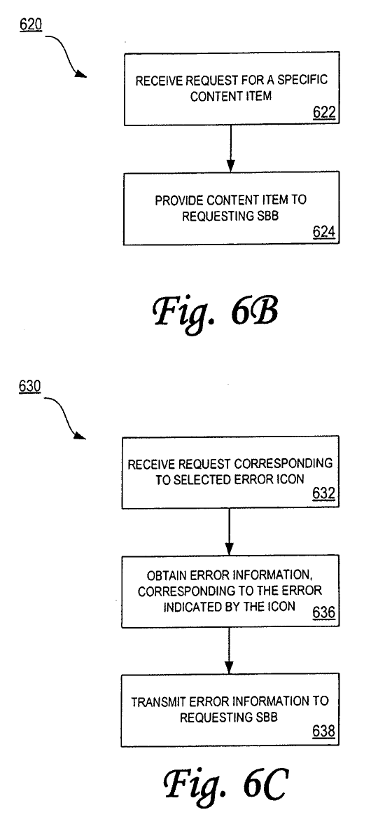

FIG. 6A illustrates one embodiment of a process 600 for a server receiving a content availability request. The process is performed by processing logic that may comprise hardware (circuitry, dedicated logic, etc.), software (such as is run on a general purpose computer system or a dedicated machine), or a combination of both.

The process begins with processing logic at a content server, such as content servers 140, receiving a request from a set back box for content that matches one or more filtering criteria (processing block 602). The factors which may impact requested content attributes may include various factor such as TV parental ratings, genre, actors, providers, etc.

Processing logic determines whether any content exists, which satisfies or matches the filtering factors, exists on the server (processing block 604). When content is available from the server, and does match the one or more factors, a response is composed indicating the content items available at the content server (processing block 606). In one embodiment, content server includes exemplary screen shots, the program rating, reviews, etc. along with the response for each content item, which such auxiliary data is available.

However, if no content is available on the server, which satisfies the request criteria, processing logic composes an error message in the form of an error icon (processing block 608). As discussed above, the error icon includes a link, such as a universal resource locator, memory pointer, error code, fetch command, etc., to data available at a content server which provides details about a specific error.

Processing logic transmits the composed response, which is either an error message or data indicating available content, to the requesting SBB (processing block 610).

FIGS. 6B and 6C illustrate embodiments of a process 620 for a server supplying requested content, and a process 630 for a server supplying information pertinent to a content request error. The processes is performed by processing logic that may comprise hardware (circuitry, dedicated logic, etc.), software (such as is run on a general purpose computer system or a dedicated machine), or a combination of both.

With respect to FIG. 6B, the process begins with processing logic receiving a request from a set back box for a specific content item (processing block 622). In response to the request, processing logic provides the requested content to the set back box (processing block 624). In one embodiment, processing logic streams the content to the set back box as an MPEG-4 compressed audiovisual stream. However, other audiovisual streams are equally applicable to the discussion herein. In another embodiment, processing logic uploads an entire content item to the requesting SBB.

With respect to FIG. 6C, the process begins with processing logic receiving a request for information corresponding to a selected error icon (processing block 622). As discussed in detail above, an error icon includes or embodies a link to data regarding the error icon. For example, if an error icon indicates no content is available at a server, the link might be to data indicating that content which does not exceed TV-14 is unavailable. Upon receiving the request, processing logic obtains error information, corresponding to the error icon, as indicated by the link (processing block 636) and transmits the information to the requesting set back box (processing block 638).

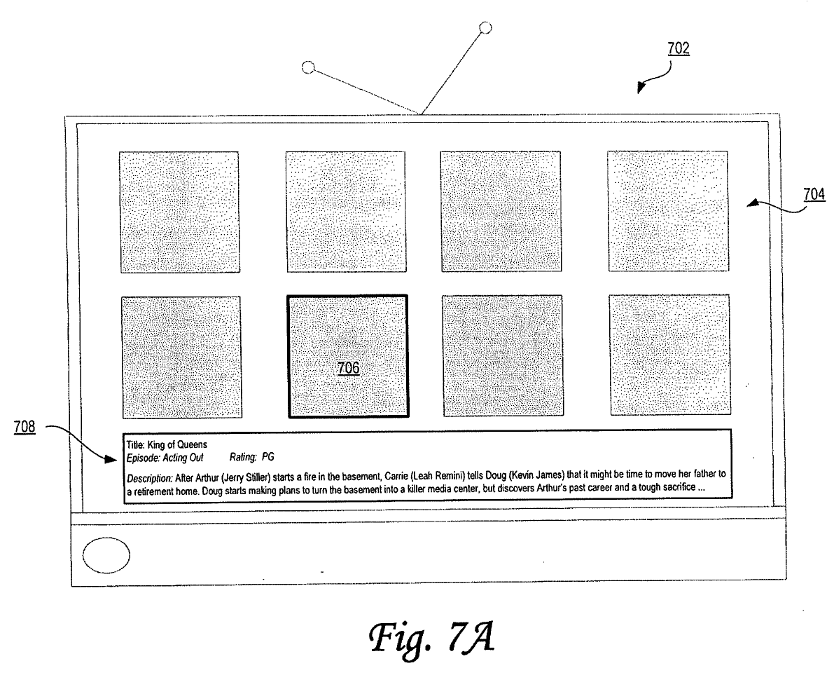

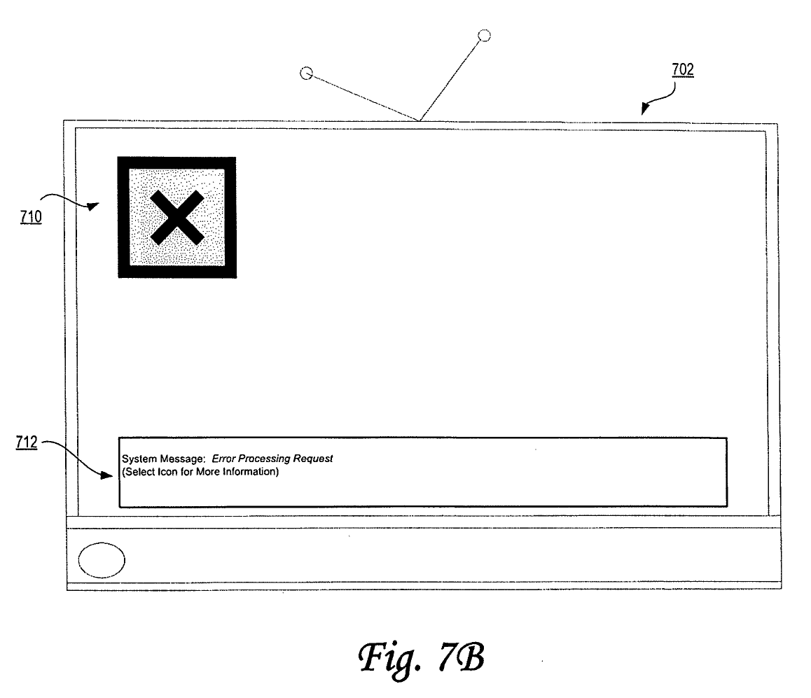

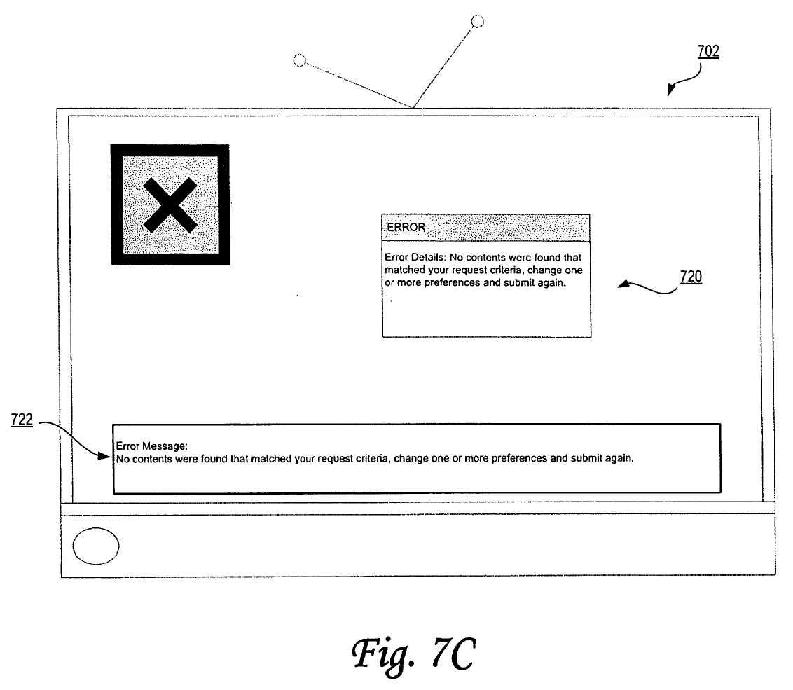

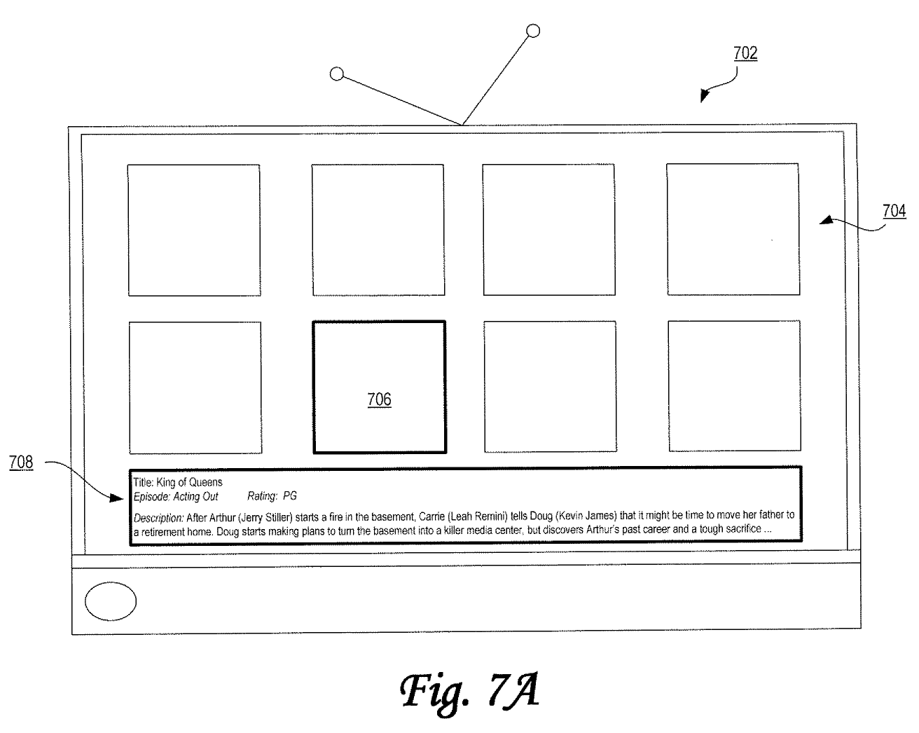

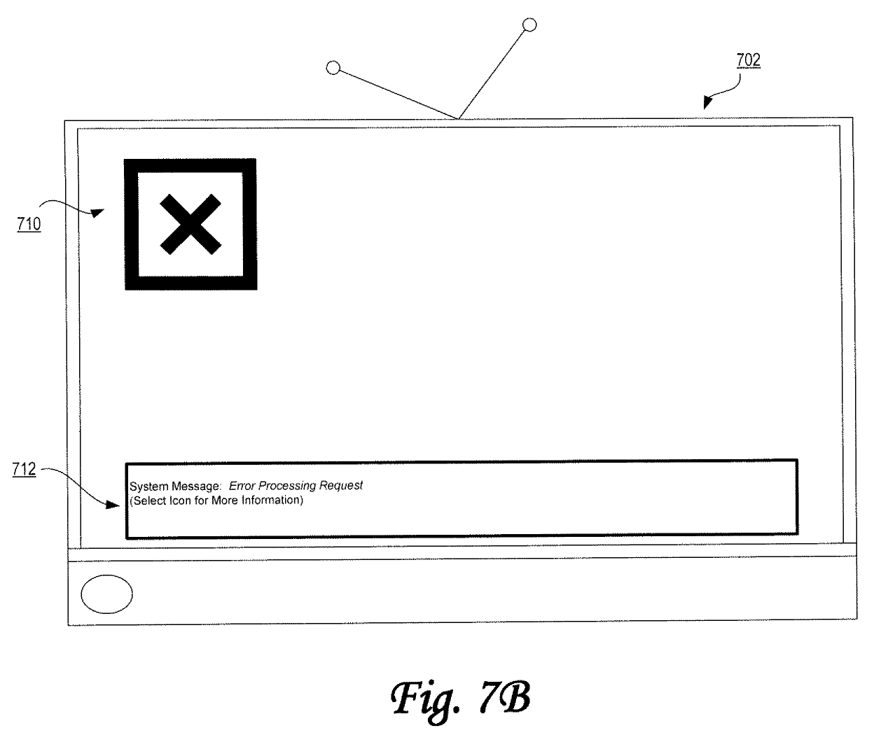

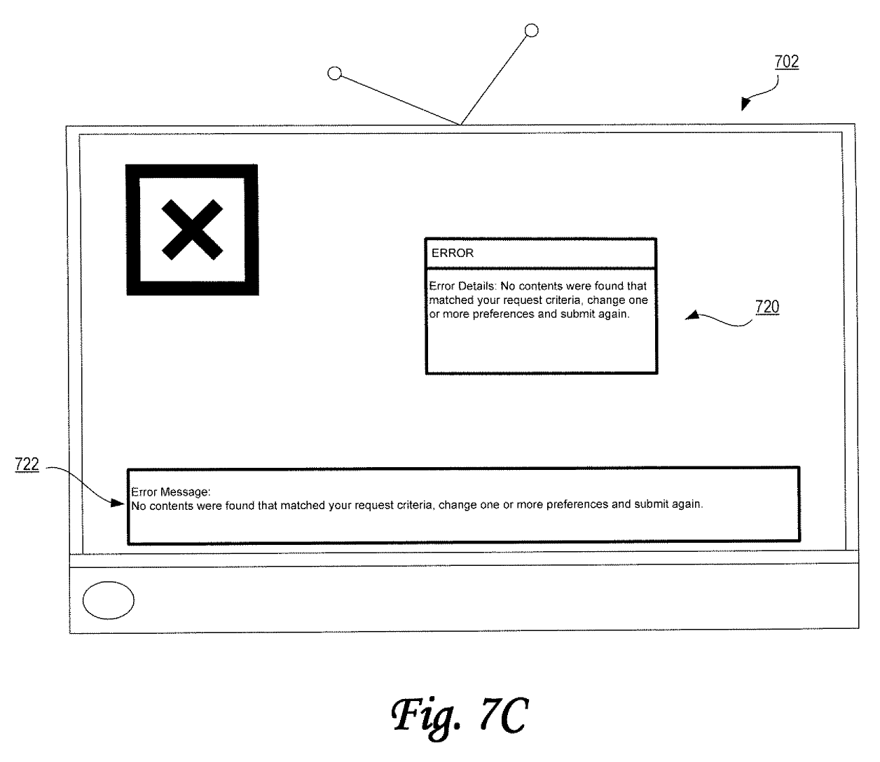

FIGS. 7A-C show exemplary representations of user interfaces facilitating request and selection of content according to some embodiments of the present invention.

In one embodiment, as illustrated in FIG. 7A, a television 702 displays a user interface 704 for requesting content. When available content items are browsed, as illustrated by the highlighting of box 706, data 708 corresponding to the content item may be displayed in user interface 704. The content item 706 may then be selected on the television, and retrieved from a server via a set back box, as described herein. However, in the case where content is not available at a content server, which satisfies a request factor such as a TV parent rating, an error icon 610 may be displayed on television 602, as illustrated in FIG. 7B. In one embodiment a brief message or description 612 may be provided along with the error icon 610. Furthermore, as noted above, the error icon 610 is user selectable such that a set back box (not shown) retrieves a specific error message, illustrated as a pop-up box 620, a detailed error message 622, or both. In each case, the error message is associated with the icon through a link.

It will be appreciated by those of ordinary skill in the art that any configuration of the system may be used for various purposes according to the particular implementation. The control logic or software implementing the present invention can be stored on a machine-readable medium locally or remotely accessible. A machine-readable medium includes any mechanism for storing or transmitting information in a form readable by a machine (e.g. a computer). For example, a tangible machine readable medium includes read-only memory (ROM), random access memory (RAM), magnetic disk storage media, optical storage media, flash memory devices, electrical, optical, or acoustical media. Non-tangible machine readable medium of other forms may include propagated signals (e.g. carrier waves, infrared signals, digital signals, etc.).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method, comprising:
receiving a request for video content, the request including at least one factor that specifies an attribute of the requested video content;
communicating the request and the at least one factor to a content server;
receiving a response indicating video content available from the content server that satisfies the at least one factor.

2. The method of claim 1, further comprising:
receiving, as the response, data indicative of video content that satisfies the at least one factor and is available at the server; and
communicating the data for display on a television.

3. The method of claim 2, further comprising:
receiving a user selection of video content from the data displayed on the television;
obtaining the video content, corresponding to the user selection, from the server; and
communicating the video content for display on the television.

4. The method of claim 2, wherein the data indicative of video content includes, for each video content item available at the server, includes one or more of a title of the video content item, description of the video content item, duration of the video content item, user ratings of the video content item, and a graphical representation of the video content item.

5. The method of claim 1, wherein the at least one factor includes a specification of a television parental rating of which the requested video content should not exceed.

6. The method of claim 1, further comprising:
receiving a response that includes an error icon indicating that video content, which satisfies the at least one factor, is not available from the server; and
communicating the error icon for display on a television.

7. The method of claim 6, wherein the error icon is a selectable icon that links to a message at the server that provides detail about the received error icon and why video content is not available from the server.

8. A set back box (SBB), comprising:
a television interface;
a network interface; and
a processor coupled with the television interface and the network interface to,
receive a request for video content from the television interface, the request including at least one factor that specifies an attribute of the requested video content;
communicate the request, including the at least one factor, to a content server via the network interface;
receiving a response that includes data indicative of video content, available at the server, that satisfies the at least one factor; and
communicating the data for display on a television.

9. The SBB of claim 8, wherein the processor is further to receive a user selection of video content from the data displayed on the television, obtain the video content, corresponding to the user selection, from the server, and communicate the video content for display on the television

10. The SBB of claim 8, wherein the processor is further to receive a response that includes an error icon indicating that video content, which satisfies the at least one factor, is not available from the server, and communicate the error icon for display on a television, the error icon being a selectable icon that links to a message at the server that provides detail about the received error icon and why video content is not available from the server.

11. The SBB of claim 8, wherein the at least one factor includes a specification of a television parental rating of which the requested video content should not exceed.

12. The SBB of claim 8, wherein the television interface comprises:
a high definition multimedia interface (HDMI) interface for communicating audio and video content received at the SBB to the television; and
a universal serial bus (USB) interface for receiving user commands and communicating non-programming content data to the television.

13. A system, comprising:
a television; and
a set back box communicatively coupled with the television, to
receive a request for video content from a television interface, the request including at least one factor that specifies an attribute of the requested video content;
communicate the request, including the at least one factor, to a content server via a network interface;
receive a response that includes data indicative of video content, available at the server, that satisfies the at least one factor; and
communicate the data via the television interface for display on the television.

14. The system of claim 13, wherein the set back box is embedded within the television.

15. The system of claim 13, wherein the set back box is communicatively coupled with the television by a high definition multimedia interface (HDMI) interface for communicating audio and video content to the television and a universal serial bus (USB) interface for receiving user commands and communicating non-programming content data to the television.

16. A computer readable medium that provides instructions, which when executed on a processing system, cause said processing system to perform a method comprising:
receiving a request for video content, the request including at least one factor that specifies an attribute of the requested video content;
communicating the request and the at least one factor to a content server;
receiving a response indicating video content available from the content server that satisfies the at least one factor.

17. The method of claim 16, further comprising:
receiving a response that includes data indicative of video content, available at the server, that satisfies the at least one factor; and
communicating the data for display on a television.

18. The method of claim 17, further comprising:
receiving a user selection of video content from the data displayed on the television;
obtaining the video content, corresponding to the user selection, from the server; and
communicating the video content for display on the television.

19. The method of claim 17, wherein the data indicative of video content includes, for each video content item available at the server, includes one or more of a title of the video content item, description of the video content item, duration of the video content item, user ratings of the video content item, and a graphical representation of the video content item.

20. The method of claim 16, wherein the at least one factor includes a specification of a parent rating of which the requested video content should not exceed.

21. The method of claim 16, further comprising:
receiving a response that includes an error icon indicating that video content, which satisfies the at least one factor, is not available from the server; and
communicating the error icon for display on a television.

22. The method of claim 21, wherein the error icon is a selectable icon that links to a message at the server that provides detail about the received error icon and why video content is not available from the server.
